(19) United States
(12) Patent Application Publication
(10) Pub. No.: US 2017/0309273 A1
(43) Pub. Date: Oct. 26, 2017

(54) LISTEN AND USE VOICE RECOGNITION TO FIND TRENDS IN WORDS SAID TO DETERMINE CUSTOMER FEEDBACK

(71) Applicant: Wal-Mart Stores, Inc., Bentonville, AR (US)

(72) Inventors: Nicholaus A. Jones, Fayetteville, AR (US); Robert J. Taylor, Rogers, AR (US); Aaron J. Vasgaard, Rogers, AR (US); Matthew A. Jones, Bentonville, AR (US)

(21) Appl. No.: 15/492,569

(22) Filed: Apr. 20, 2017

Related U.S. Application Data
(60) Provisional application No. 62/325,561, filed on Apr. 21, 2016.

(51) Int. Cl. G10L 15/22; G10L 21/0272; G06Q 30/06; G10L 15/30; H04R 1/40; G10L 25/48

(52) U.S. Cl. CPC G10L 15/22; H04R 1/406; G10L 25/48; G06Q 30/0601; G10L 15/30; G10L 21/0272

(57) ABSTRACT

In some embodiments, apparatuses, systems, and methods are provided herein for performing sound analysis in a shopping facility. A system for performing sound analysis comprises: an array of sound sensors distributed throughout a shopping facility and configured to receive at least sounds resulting from people in the shopping facility, an audio database including information associated with one or more audio indicia, and a control circuit communicatively coupled to the array of sound sensors and configured to receive, from a plurality of sensors of the array of sound sensors, audio data, wherein the audio data includes audio from throughout the shopping facility, determine, based at least in part on the audio data and the information associated with the one or more audio indicia included in the audio database, an action be taken, and transmit, to a terminal, an indication of the action to be taken.

### CROSS-REFERENCE TO RELATED APPLICATION

This application claims the benefit of U.S. Provisional Application No. 62/325,561, filed Apr. 21, 2016, which is incorporated herein by reference in its entirety.

### TECHNICAL FIELD

This invention relates generally to sound analysis and, more specifically, to sound analysis in a shopping facility.

### BACKGROUND

Oftentimes, guests of a shopping facility discuss their thoughts regarding the shopping facility with other guests. Additionally, guests of a shopping facility may cause production of noises that indicate their thoughts about the shopping facility. It would be beneficial to leverage such audio content to improve the shopping experience for guests of the shopping facility.

### BRIEF DESCRIPTION OF THE DRAWINGS

Disclosed herein are embodiments of systems, apparatuses, and methods pertaining sound analysis in a shopping facility. This description includes drawings, wherein:

FIG. 1 depicts a shopping facility 104 including an array of sound sensors 106, according to some embodiments.

FIG. 2 is a block diagram of a system 200 for performing sound analysis and determining tasks to be performed based on the sound analysis, according to some embodiments.

FIG. 3 is a flow chart depicting example operations for performing sound analysis and determining actions to perform based on the sound analysis, according to some embodiments.

FIG. 4 is a diagram of a shopping facility 402 in which sounds 406 are captured by sound sensors, according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses, and methods are provided herein useful for performing sound analysis and determining an action to perform based on the sound analysis. In some embodiments, a sound analysis system comprises an array of sound sensors distributed throughout a shopping facility and configured to receive at least sounds resulting from people in the shopping facility, an audio database including information associated with one or more audio indicia, and a control circuit. The control circuit is communicatively coupled to the sound sensors. The control circuit is configured to receive, from a plurality of sensors of the array of sound sensors, audio data, wherein the audio data includes audio from throughout the shopping facility. The control circuit is further configured to determine, based at least in part on the audio data and the information associated with the one or more audio indicia included in the audio database, an action to be taken and transmit, to a terminal, and indication of the action to be taken.

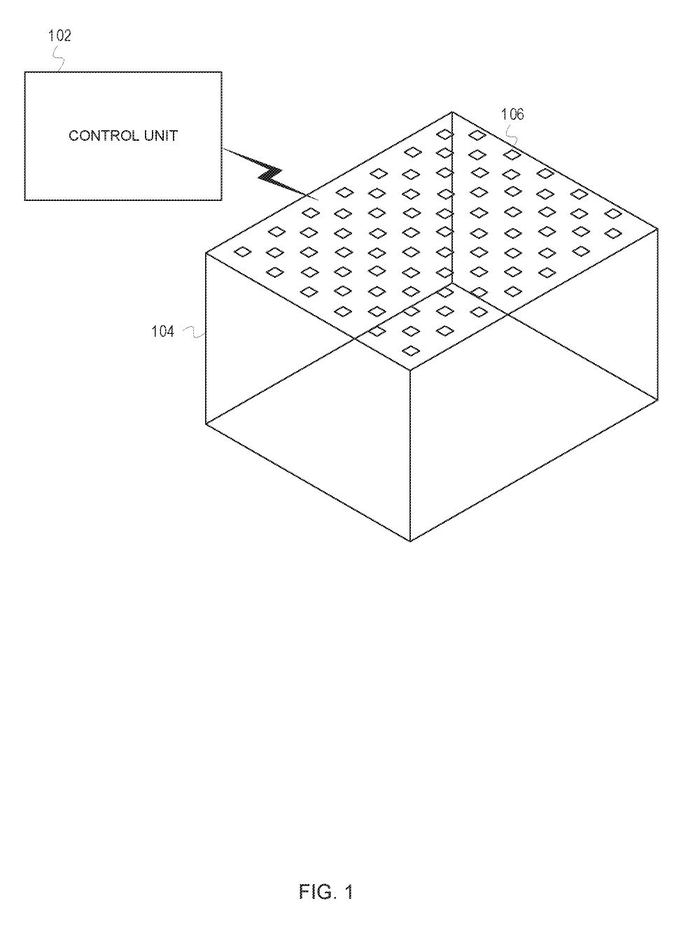

Knowing and understanding guest actions and reactions within a shopping facility can provide valuable information regarding actions to perform within the shopping facility. For example, if guests are generally dissatisfied with the cleanliness of the shopping facility, greater resources can be devoted to maintaining the cleanliness of the shopping facility. However, it is difficult to not only be aware of guest actions and reactions within the shopping facility, but also aggregate the information and determine an appropriate task to perform to increase guest satisfaction. Embodiments of the inventive subject matter utilize sound sensors to perceive aural cues as to guest feelings about a shopping facility. The aural cues are aggregated and used to determine actions to perform that will increase guest satisfaction within the shopping facility. FIG. 1 provides a general overview of such a system.

FIG. 1 depicts a shopping facility 104 including an array of sound sensors 106, according to some embodiments of the inventive subject matter. The sound sensors 106 are located throughout the shopping facility. For example, as depicted in FIG. 1, the sound sensors 106 can be located in the ceiling of the shopping facility 104. However, the locations of the sound sensors 106 can vary based on need. For example, the sound sensors 106 can be located within product display units (e.g., shelves), support columns, or in any other suitable location. Additionally, the sound sensors 106 can be located throughout the entire shopping facility 104 (as depicted in FIG. 1) or concentrated in one or more specific areas of interest of the shopping facility 104. In some embodiments, the sound sensors 106 may be hidden from view.

The sound sensors 106 detect sounds resulting from guest activity within the shopping facility 104. The sounds resulting from guest activity within the shopping facility 104 can include voices (e.g., guests speaking—approximately in the 85 to 255 Hz range), sounds produced by electronic devices carried by guests (e.g., mobile devices), and sounds produced by guest moving throughout the shopping facility (e.g., footsteps, rustling of clothing, or movement of products).

As the sound sensors 106 perceive sounds resulting from guest activity in the shopping facility 104, the sound sensors 106 transmit audio data to a control circuit 102. In some embodiments, the control circuit 102 is local to the shopping facility 104. For example, the control circuit 102 can be located in a back office of the shopping facility 104. In other embodiments, the control circuit 102 is remote from the shopping facility 104. For example the control circuit 102 can be located in a home office or regional office. Upon receiving the audio data, the control circuit 102 processes the audio data and determines an action to be taken based on the audio data. As a simple example, the sound sensors 106 can detect the sound of a guest stating that an aisle of the shopping facility 104 is dirty. The sound sensors 106 transmit this audio data to the control circuit 102. The control circuit processes the audio data and determines that a cleaning action should be taken based on the guest stating that the aisle is dirty. Additionally, if the action to be taken is an investigatory action, an automated device, such as an aerial or terrestrial drone, can be dispatched to investigate. For example, the automated device can be equipped with a camera that relays images of the area of the shopping facility 104 in question. In some embodiments, control circuit 102 can transmit an indication of the action to be taken to a terminal within the shopping facility 104. For example, the control circuit 102 can transmit an indication that the cleaning action should be taken to an employee terminal.

Further, in some embodiments, the system can employ filtering to limit the amount of audio data that needs to be processed. For example, the system can employ a filter, such as a high pass, low pass, or bandpass filter to remove superfluous audio data. The filter can aid in removing background noise such as that from an HVAC system, a lighting system, etc.

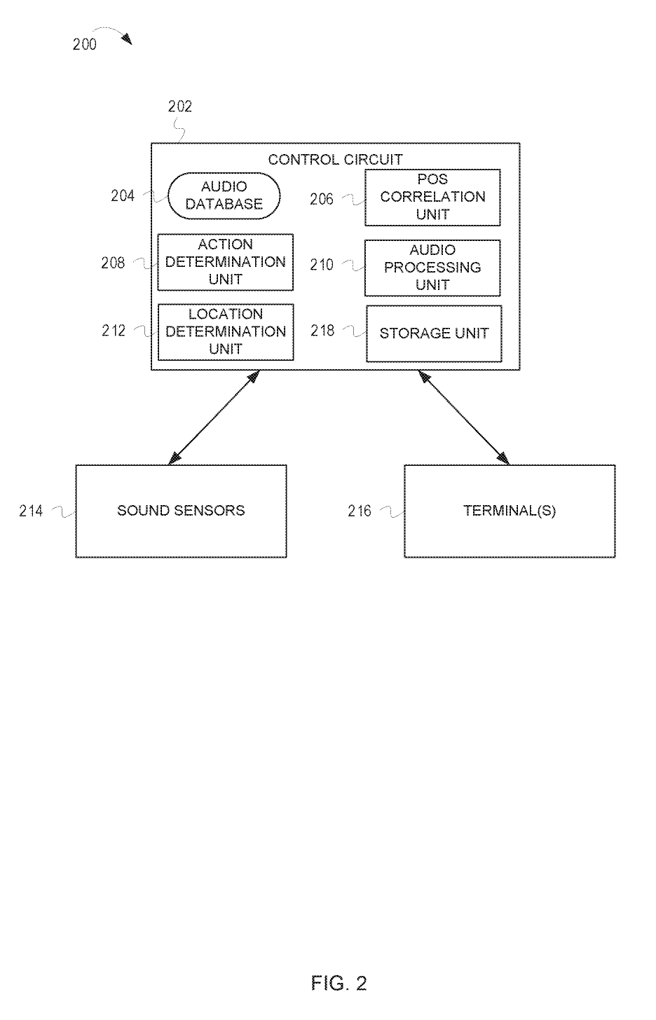

While FIG. 1 and the associated text provide an overview of some embodiments of the inventive subject matter, FIG. 2 provides, in more detail, and example system for performing sound analysis in a shopping facility.

FIG. 2 is a block diagram of a system 200 for performing sound analysis and determining tasks to be performed based on the sound analysis, according to some embodiments of the inventive subject matter. The system 200 includes sound sensors 214, a terminal 216, and a control circuit 202. The control circuit 202 may include a processing device and a memory device and may generally be any processor-based device such as one or more of a computer system, a server, a networked computer, a cloud-based server, etc. The processor device may comprise a central processing unit, a processor, a microprocessor, and the like. The processing device may be configured to execute computer readable instructions stored on the memory. As previously discussed, the sound sensors 214 can be located throughout an entire shopping facility or a portion of a shopping facility. The sound sensors 214 detect sounds resulting from guest activity in the shopping facility and transmit audio data to the control circuit 202.

The control circuit 202 includes a point-of-sale (“POS”) correlation unit 206, an action determination unit 208, an audio processing unit 210, a location determination unit 212, and a storage unit 218. Additionally, in some embodiments, the control circuit includes an audio database 204 (however, in other embodiments, the audio database 204 may include hardware and/or software that is separate from the control circuit 202). After receiving the audio data, the audio processing unit 210 processes the audio data. For example, the audio processing unit 210 can perform speech recognition. In addition to performing speech recognition, the audio processing unit 210 can also identify sounds other than speech. For example, the audio processing unit 210 can be programmed to recognize sounds produced by electronic devices, such as audio produced by applications executing on a mobile device (e.g., sounds generated while scanning barcodes, sounds consistent with a mobile assistant application, etc.). In some embodiments, the audio processing unit 210 can reference the audio database 204 when processing the audio data and/or recognizing sounds.

After processing the audio data, the action determination unit 208 determines an action to be taken. The action to be taken can be any type of action within the shopping facility or a home or regional office. For example, the action can be a cleaning action (e.g., instruct an employee to clean an area of the shopping facility), a stocking action (e.g., instruct an employee to check the stock level of a product or restock a product), a verification action (e.g., instruct an employee to verify the price or location of a product), a deployment action (e.g., instruct an employee to proceed to a specific location in the shopping facility to provide assistance), an investigatory action (e.g., compare the current price of a product with a wholesale price), a staffing action (e.g., move more cashiers to the frontend), a pricing action (e.g., adjust the price of a product), a reporting action (e.g., create a report of common guest thoughts, comments, and/or activities in a shopping facility), or an action to store the audio data (e.g., categorize and store the audio data in memory). In some embodiments, the action determination unit 208 only determines an action be taken in response to the occurrence of a trigger sound, word, or phrase. For example, the audio database 204 can include a list of trigger sounds, words, and phrases. The trigger sounds, words, and phrases can be specific sounds, words, and phrases of interest, such as sounds created by mobile devices (e.g., sounds generated by applications running on the mobile device or a person interacting with the mobile device) and words or phrases about products, the shopping facility, etc. Upon detection of one of the trigger sounds, words, or phrases, the audio processing unit 210 can direct the action determination unit 208 to determine an action to be taken based on the audio data. In some embodiments, occurrence of a word, phrase, or sound in a single instance will not cause the action determination unit 208 to determine an action to perform. Instead, aggregation of similar words, phrases, and/or sounds over time may cause the action determination unit 208 to determine an action to be taken. For example, if a single guests makes a remark that is negative but not negative with regard to a specific aspect of the shopping facility, the action determination unit 208 may determine that no action should be taken. However, if overtime there is a pattern of guests making generally negative comments in a specific area of the shopping facility, the action determination unit 208 may determine that an investigatory action should be taken to determine a cause of the general negative feelings about the location of the shopping facility.

In some embodiments, the action determination unit 208 can utilize information in addition to, or in lieu of, the audio data. Specifically, the action determination unit 208 can receive information from the POS correlation unit 206 and/or the location determination unit 212 when determining an appropriate action to take based on the audio data. The location determination unit 212 can analyze the audio data to determine and/or estimate a location from which the sound arose (i.e., from where the sound originated). In some embodiments, the audio data can include identifiers of the sound sensors 214 from which the sound originated. In such embodiments, the location determination unit 212 can, based on known sound sensor locations and the identifiers, use triangulation or trilateration to determine the location from which the sound originated. Additionally, the location determination unit 212 can consider signal strength of the sound to determine and/or estimate the location from which the sound arose. Knowing the location from which the sound originated can help determine which action should be taken in many ways. For example, if the audio data simply indicate that the price for a product seems high, but do not identify the product, the location from which the sound originated can be used to determine to which product the guest was referring. As another example, knowing the location from which the sound originated can be helpful in providing assistance to a guest, restocking a product display, cleaning an area of the shopping facility, changing or modifying signage, or otherwise improving the shopping facility or shopping experience for the guests.

In some embodiments information from the POS correlation unit 206 can be used to determine the appropriate action to be taken. In such embodiments, the action determination unit 208 can use POS data to determine the meaning of an ambiguous sound. For example, if the sound is a guest uttering an ambiguous phrase such as “wow,” the guest could be expressing surprise over what he/she believes to be a good price, or the guest could be expressing disappointment over what he/she believes to be a bad price. The action determination unit 208 can store (e.g., in the storage unit 218 as well as date/time and/or location information) the audio data and any product identifying information (either explicit product identification information if available or inferential product information based on a location from which the sound originates) and monitor POS data. If ambiguous phrases are heard regularly with regard to the product and the POS data indicates that sales are high for the product, the action determination unit 208 can infer that guests believe the price for the product to be a good one. In response, the action determination unit 208 can determine that the appropriate action to be taken is to increase signage near the product to advertise the price. Conversely, if the POS data indicates that the product is not selling well, the action determination unit 208 can infer that guests do not believe the price for the product to be a good one. In response, the action determination unit 208 can determine that the appropriate action to be taken is a local action to verify the price of the product and/or a remote action to investigate pricing for the product and sales information for other shopping facilities.

After determining the action to be taken, the control circuit 202 transmits an indication of the action to be taken to the terminal 216. The terminal 216 can be local to the shopping facility. For example, one or more terminals 216 can be located in a stock room, back office, employee breakroom, or on the shopping floor within the shopping facility (e.g., kiosks, registers, etc.). Additionally, some or all of the employees can carry handheld terminals 216. Additionally, the terminal 216 can be located remotely from the shopping facility (e.g., in a home office, regional office, distribution center, etc.). In some embodiments, there are terminals 216 both local to, and remote from, the shopping facility. The control circuit 202 can transmit the indication of the action to be taken to all local and remote terminals 216, all local terminals 216, all remote terminals 216, or portions of the local and/or remote terminals 216. The terminals 216 to which the control circuit transmits the indication of the action to be taken can be based on the action to be taken. For example, if the action to be taken is a cleaning action, the control circuit 202 can transmit the indication of the action to be taken to all handheld terminals 216 near the location of the action to be taken. As another example, if the action to be taken is common to multiple shopping facilities (e.g., an investigatory action regarding pricing), the control circuit 202 can transmit the indication of the action to be taken to certain remote terminals 216. After receiving the indication of the action to be taken, the terminals 216 present the indication of the action to be taken. In some embodiments, the terminals 216 can include functionality which allows an employee to mark the indication of the action to be taken as completed, or will be completed, by him/her. Such markings may be broadcast to the terminals 216.

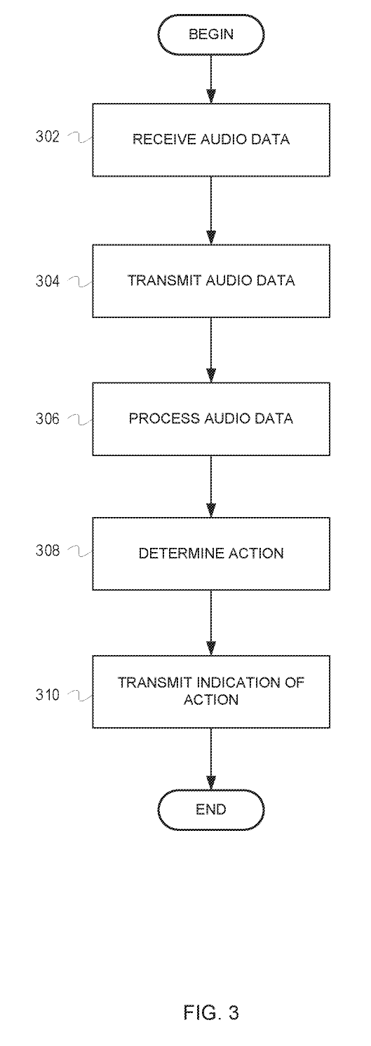

While FIG. 2 and the associated text describe a more detailed system for performing sound analysis in a shopping facility, FIG. 3 is a flow diagram depicting example operations of the system.

FIG. 3 is a flow chart depicting example operations for performing sound analysis and determining actions to perform based on the sound analysis, according to some embodiments of the inventive subject matter. The flow beings at block 302.

At block 302, the audio data is received. For example, the audio data can be received by one or more sound sensors located in a shopping facility. The audio data can result from sounds occurring throughout the entire shopping facility, or just a portion of the shopping facility. In some embodiments, the sound sensors are spread throughout the shopping facility in such a manner that audio data resulting from sounds on opposite ends of the shopping facility can be received continuously and simultaneously, or over a desired distance continuously and simultaneously. The sound sensors can be positioned in an array or any other suitable pattern and can be located in any suitable location in the shopping facility (e.g., in the floor, ceiling, product displays, etc.). The flow continues at block 304.

At block 304, the audio data is transmitted. For example, the audio data can be transmitted from the sound sensors to a control circuit. In some systems, the control circuit is located locally to the sound sensors (e.g., in a backroom or office of the shopping facility). In other systems, multiple control circuits may exist and be located remotely from the shopping facility. For example, control circuits may be located in each regional office and receive audio data for shopping facilities associated with their respective regional offices. In some embodiments, the audio data is simply the sounds detected by the sound sensors. In other embodiments, the audio data can also include information such as timestamps, sound sensor identifiers, location information, etc. or be otherwise processed (e.g., preprocessing for sound quality, sound clarity, etc.). Additionally, the audio data can be streamed in real time (or near real time) or stored locally before transmission. The flow continues at block 306.

At block 306, the audio data is processed. For example, the audio data can be processed by the control circuit. The control circuit can perform speech recognition and any other type of audio recognition on the audio data. In some embodiments, the control circuit searches for trigger sounds, words, and/or phrases within the audio data. The flow continues at block 308.

At block 308, an action to be taken is determined. For example, the control circuit can determine one or more actions to be taken based on the processing of the audio data. The action to be taken can be specific to a shopping facility or be an action to be taken at, or with regard to, all shopping facilities. Additionally, the control circuit can determine multiple actions to be taken at multiple locations and/or by multiple actors based on the audio data. For example, if the audio data indicates that a product is not properly stocked on a shelf and historical audio data indicates that improper stocking is a common occurrence, the control circuit can determine that an employee should take a restocking action and that a product display manager take an investigatory action as to whether there exists a better way to present the product to avoid future improper stocking situations. In this regard determination of an action to be taken can be based on current audio data as well as audio data aggregated over time. To facilitate determination of actions to be taken based on audio data aggregated over time, the control circuit can store in memory audio data (including timestamps, locations, etc.) and prior actions taken. When making future determination as to actions to be taken, the control circuit can reference this aggregated data and base a determination on this data and/or alter a determination based on this aggregated data. The flow continues at block 310.

At block 310, an indication of the action to be taken is transmitted. For example, the control circuit can transmit an indication of the action to be taken. The control circuit can transmit an indication of the action to be taken to one or more terminals local or remote to the shopping facility. The indication of the action to be taken can indicate the action to be taken as well as any other information relevant to the action to be taken. For example, if the action is a stocking action, the indication of the action to be taken can include an indication of the product that needs to be stocked as well as an indication of that product's location in the shopping facility. As another example, if the action to be taken is an investigatory pricing action, the indication of the action to be taken can include an indication of the product, recent sales data for the product (from one or more shopping facilities), and a current price for the product.

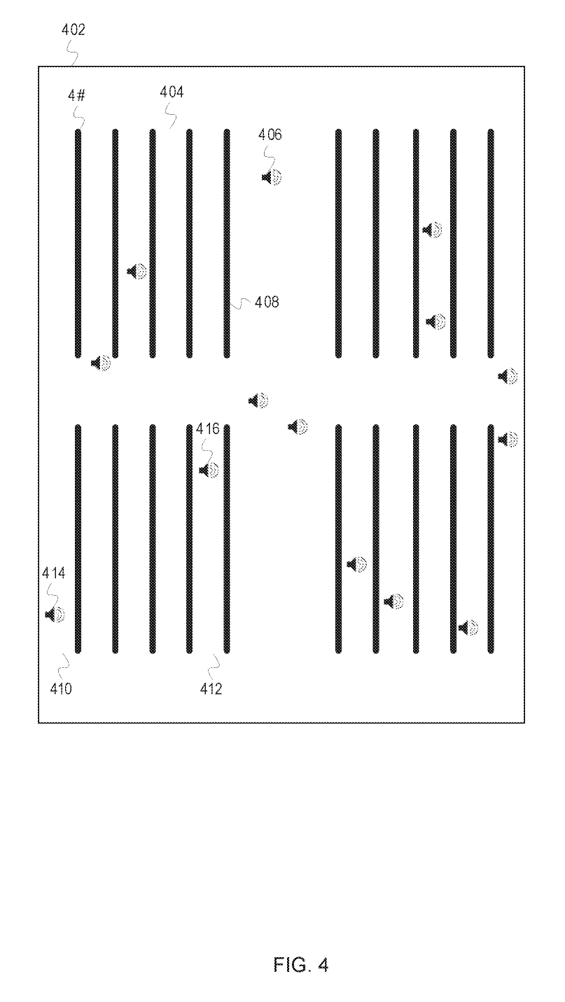

FIG. 4 is a diagram of a shopping facility 402 in which sounds 406 are captured by sound sensors, according to some embodiments. The shopping facility 402 includes a number of product display units 408 (e.g., shelves) that form aisles 404. The sounds 406 originate throughout the shopping facility 402. The sounds 406 are produced by activity in the shopping facility 402. The sounds 406 can be produced by human activity (talking, walking, manipulating products, etc.) or automated activity (e.g., automated floor scrubbers). In some embodiments, the sound sensors capture sounds that occur in locations that are physically distant from one another in the shopping facility 402. For example, the sound sensors may capture a first sound 414 in a first aisle 410 and a second sound 416 in a second aisle 412 that are at least four aisles apart (i.e., the first aisle 410 is four aisles from the second aisle 412).

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept. For example, although FIGS. 1-4 and the related text refer to the example of determining actions to be taken based on sounds resulting from guest activity in a shopping facility, embodiments are not so limited. For example, in some embodiments, sounds resulting from activity of any persons (e.g., employees, contractors, guests, etc.) may be detected by the sound sensors and a control circuit can determine appropriate actions to be taken based on these sounds.

In some embodiments, a sound analysis system comprises an array of sound sensors distributed throughout a shopping facility and configured to receive at least sounds resulting from people in the shopping facility, an audio database including information associated with one or more audio indicia, and a control circuit. The control circuit is communicatively coupled to the sound sensors. The control circuit is configured to receive, from a plurality of sensors of the array of sound sensors, audio data, wherein the audio data includes audio from throughout the shopping facility. The control circuit is further configured to determine, based at least in part on the audio data and the information associated with the one or more audio indicia included in the audio database, an action to be taken and transmit, to a terminal, and indication of the action to be taken.

In some embodiments, a method of sound analysis includes receiving, via an array of sound sensors distributed throughout a shopping facility and configured to receive at least sounds resulting from people in the shopping facility, audio data, wherein the audio data includes audio from throughout the shopping facility, transmitting, via a communications network, the audio data to a server, processing, at the server, the audio data relative to information in a database that is associated with one or more audio indicia, determining, based on the processing and the information in the database that is associated with one or more audio indicia, one or more actions be taken in response to the audio data, and transmitting, via the communications network, an indication of the one or more actions to be taken.

What is claimed is:

1. A sound analysis system in a shopping facility, the sound analysis system comprising:
an array of sound sensors distributed throughout the shopping facility and configured to receive at least sounds resulting from people in the shopping facility;
an audio database including information associated with one or more audio indicia; and
a control circuit communicatively coupled to the array of sound sensors, the control circuit being configured to:
receive, from a plurality of sensors of the array of sound sensors, audio data, wherein the audio data includes audio from throughout the shopping facility;
determine, based at least in part on the audio data and the information associated with the one or more audio indicia included in the audio database, an action to be taken; and
transmit, to a terminal, an indication of the action to be taken.

2. The sound analysis system of claim 1, wherein the audio data is resultant from one or both of guest activity and employee activity.

3. The sound analysis system of claim 1, wherein the control circuit is configured to determine, based at least in part on the audio data, known sensor locations, and corresponding signal strength measurements, an estimated location of sources of the audio data.

4. The sound analysis system of claim 1, wherein the audio data includes one or more of speech, voices, words, phrases, and sounds produced by devices and the people in the shopping facility.

5. The sound analysis system of claim 1, wherein the one or more actions to be taken include one or more of a cleaning action, a stocking action, a verification action, a deployment action, an investigatory action, and an action to store the audio data.

6. The sound analysis system of claim 1, wherein the database further includes one or more trigger sounds, and wherein the control circuit is further configured to:
determine, based, at least in part, on the one or more trigger sounds, that the audio data includes at least one of the one or more trigger sounds; and
wherein the determination of the action to be taken is in response to the determination that that audio data includes at least one of the one or more trigger sounds.

7. The sound analysis system of claim 6, wherein the one or more trigger sounds comprise one or more of sounds that originate from an electronic device, predetermined words, and predetermined phrases.

8. The sound analysis system of claim 1, wherein the audio database includes a list of actions, and wherein the action to be taken is chosen from the list of actions.

9. The system of claim 1, wherein at least some of the sensors in the array of sensors are hidden from view.

10. The system of claim 1, wherein the audio throughout the shopping facility includes at least a first audio stream originating from a first location and a second audio stream originating from a second location, and wherein the first location is at least four aisles away from the second location.

11. A method of sound analysis in a shopping facility, the method comprising:
receiving, via sensors of an array of sound sensors distributed throughout the shopping facility and configured to receive at least sounds resulting from people in the shopping facility, audio data, wherein the audio data includes audio from throughout the shopping facility;
transmitting, via a communications network, the audio data to a server;
processing, at the server, the audio data relative to information in a database that is associated with one or more audio indicia;
determining, based on the processing and the information in the database that is associated with one or more audio indicia, one or more actions to be taken in response to the audio data; and
transmitting, via the communications network, an indication of the one or more actions to be taken.

12. The method of sound analysis of claim 11, wherein the audio data is resultant from one or both of guest activity and employee activity.

13. The method of sound analysis of claim 11, wherein the control circuit is configured to determine, based at least in part on the audio data, known sensor locations, and corresponding signal strength measurements, an estimated location of sources of the audio data.

14. The method of sound analysis of claim 11, wherein the audio data includes one or more of speech, voices, words, phrases, and sounds produced by devices and the people in the shopping facility.

15. The method of sound analysis of claim 11, wherein the one or more actions to be taken include one or more of a cleaning action, a stocking action, a verification action, a deployment action, an investigatory action, and an action to store the audio data.

16. The method of sound analysis of claim 11, further comprising:
determining, based, at least in part, on a database, that the audio data includes a trigger sound; and
wherein the determining the one or more actions to be taken is in response to the determining that the audio data includes a trigger sound.

17. The method of sound analysis of claim 16, wherein the trigger sound comprises one or more of sounds that originates from an electronic device, predetermined words, and predetermined phrases.

18. The method of sound analysis of claim 11, wherein the audio database includes a list of actions, and wherein the action to be taken is chosen from the list of actions.

19. The method of sound analysis of claim 11, wherein the audio data comprises speech, and wherein the processing the audio data comprises:
performing speech recognition on the audio data.

20. The method of sound analysis of claim 11, wherein the audio throughout the shopping facility includes at least a first audio stream originating from a first location and a second audio stream originating from a second location, and wherein the first location is at least four aisles away from the second location.
